(19) United States
(12) Patent Application Publication
(10) Pub. No.: US 2004/0166223 A1
(43) Pub. Date: Aug. 26, 2004

(54) Concentrated juice and methods for producing the same

(75) Inventors: Harapanahalli S. Muralidhara, Plymouth, MN (US); Bassam Jirjis, Plymouth, MN (US); Jose Passarelli, Bebeduro (BR); Doil Williams, Shakopee, MN (US)

Correspondence Address: BANNER & WITCOFF, 1001 G STREET N W, SUITE 1100, WASHINGTON, DC, 20001, US

(73) Assignee: Cargill Inc., Wayzata, MN (US)

(21) Appl. No.: 10/374,901

(22) Filed: Feb. 26, 2003

(51) Int. Cl. C12H 1/04

(52) U.S. Cl. 426/599; 426/422

(57) ABSTRACT

Juice is concentrated by passing a feed juice over a reverse osmosis membrane to form a retentate. The retentate is recirculated over the membrane until the feed juice and the retentate reach from between 20° Brix to about 25° Brix to form a juice concentrate.

### FIELD OF THE INVENTION

This invention relates to a non-thermal method for concentrating fruit juices having just squeezed flavor and fragrance and to the concentrated juice product produced using this method.

### BACKGROUND OF THE INVENTION

Freshly squeezed juice is the preferred product of consumers; however it is not widely available throughout the year because of limited growing seasons. It is also not widely available at locations far from the areas where the fruit is grown because it is time and cost prohibitive to ship fresh fruit for juicing. It is preferable, therefore, to extract the juice from the fruit near the place of growth, and to then transport the juice for use in other locations. Although the fruits are juiced, shipping costs to locations far from the place where the fruit is grown remain high.

To reduce shipping costs, fruit juices are concentrated or otherwise processed at or near their place of growth. This not only reduces shipping costs, but also aids in achieving longer storage times, which is also advantageous. The current method of concentrating juice is not optimal and often involves steps that detract from the characteristics desired by consumers. In addition, the current methods are not energy efficient. Said in another way, the flavor, aroma, appearance, and mouth feel of freshly squeezed juice is not retained by juice produced using current high energy consuming methods.

For example, the conventional method of preparing an orange juice concentrate is by evaporation concentration. This is generally done by a process known as thermally accelerated short time evaporation (TASTE). In this process, juice passes through preheaters to destroy microorganisms and enzymes and then passes through several stages of evaporators. The actual time the juice is at an elevated temperature is usually about 6 to 8 minutes.

In methods using evaporation concentration, such as TASTE, a significant portion of the various volatile alcohols, esters, and aldehydes, which constitute a portion of the flavor and aroma components of juice, come off with the first 15 to 20% of the water vaporized. This is referred to as the “essence” or as organoleptic properties of the juice. Loss of the essence causes significant deterioration in the quality of the juice. To overcome the loss of the essence, some of the aqueous essence can be recovered from the first stage of the evaporation process by concentrating the essence in fractionating columns and then adding it back to the final concentrate. Still, only a fraction of the original compounds are recovered and added back into the final concentrate. This is because the heating process that initially separated the essence from the juice destroyed a portion of the essence.

Alternate methods of producing juice concentrates without subjecting the flavor and aroma components to heat have also been developed. These methods employ freeze concentration or sublimation concentration. In freeze concentration, extracted juice is centrifuged to separate a pulp portion and a serum portion. The serum portion is freeze concentrated and the concentrate added back to the pulp portion. In this process, however, the organoleptic properties, such as the aroma and flavor compounds are entrained in significant proportions in ice crystals and separated from the freeze concentrate resulting in a loss of flavor and aroma components and also a decrease in the quality of the product. In sublimation concentration, the extracted juice is separated into a pulp and a serum portion, as in freeze concentration. Water is removed from the serum as pure vapor using a freeze drying apparatus. In both freeze concentration and sublimation concentration, undesirable oxidation products can result which impart an off-flavor. Although processes involving freeze concentration and sublimation concentration have claimed retention of at least 65% of the volatile flavor compounds, even greater retention of flavor and aroma components is desired.

Another method developed uses ultrafiltration to preferentially pass an ultrafiltration permeate containing flavor and aroma components while retaining spoilage microorganisms in an ultrafiltration retentate. The ultrafiltration retentate from the first step is treated to inactivate, by heating, a sufficient number of spoilage microorganisms.

The ultrafiltration permeate is then fed to a reverse osmosis (RO) unit to concentrate the flavor and aroma components as a RO retentate. The RO unit was not used as the first step in this method because of the problems associated with membrane clogging and fruit proteins and polysaccharides gelling onto the membrane. The treated ultrafiltration retentate is then recombined with the RO retentate.

Nevertheless, it has been found that flavor and aroma losses still occur and the final product quality is not as good as desired. It is hypothesized that some flavor and aroma components are retained in the ultrafiltration retentate even though the pore size (about 20,000 to 100,000 MWCO) theoretically should allow all such components (molecular weight of about 30 to 155) to pass through. Additionally, it is hypothesized that the product is adversely affected if the processing time for the ultrafiltration retentate is too long, even if the process time is at low temperatures.

Previously, the fruit concentrating industry has found that by using ultrafiltration membranes sized to allow the flavor and aroma components to pass through a gel layer forms on the surface of the membrane reducing the effective pore size and resulting in retention of the smaller aroma and flavor components in the ultrafiltration retentate. In addition, the membranes tend to become plugged or clogged, particularly at high concentrations of soluble and insoluble components. As the membrane becomes plugged, the processing time for the ultrafiltration retentate increases and product quality declines.

Another method used is direct osmotic concentration (DOC). DOC uses semipermeable membranes. However, instead of squeezing water out with pressure, DOC uses a solution with a lower mole fraction of water to pull water out of a product. This solution with a low mole fraction of water is an osmotic agent. In DOC, any water pulled from the product into the osmotic agent must be subsequently removed from the osmotic agent, preferably by evaporation for the osmotic agent to be recycled. Evaporation of the osmotic agent does not affect product quality because the product itself is not heated. Since DOC requires an evaporation step, its energy requirement is similar to evaporative concentration.

In previously known methods, concentrating products containing large organic molecules and solutions with suspended solids (e.g., pulp from orange juice) created severe membrane fouling problems, particularly in RO systems. This was so even when a product is first filtered to remove suspended solids. Said in another way, there was still severe membrane fouling due to the deposition of films on the surfaces of the RO membranes.

It is an object of this invention to produce a concentrated juice product using a non-thermal process so that the juice retains the flavors and aromas of fresh squeezed juice and to save on costs, such as supply chain, transportation, and energy.

### SUMMARY

These and other objects are satisfied by the methods and products disclosed herein.

According to one aspect, a method of concentrating juice comprises passing a feed juice over a reverse osmosis membrane to form a retentate. The retentate is recirculated over the membrane until the feed juice and the retentate reach from between 20° Brix to about 25° Brix to form a juice concentrate.

According to another aspect, a method of concentrating juice comprises providing a feed juice comprising between about 7% to about 18% pulp solids by volume and approximately between 4° Brix to about 12° Brix. The feed juice may then be passed through a heat exchanger to maintain the feed juice at approximately between 20° C. to about 25° C. The feed juice may then be passed in a continuous stream tangentially over a spiral wound reverse osmosis membrane to form a retentate. The spiral wound membrane may also have a pore size of from between 0.1 Å to about 100 Å. The retentate may then be recirculated through the heat exchanger and over the membrane until the feed juice and the retentate reach from between 20° Brix to about 25° Brix to form a juice concentrate. The feed juice may be passed over the membrane at about between 250 psi to about 1000 psi, and the membrane may comprise a pressure drop across the membrane of from between 30 psi to about 150 psi or from between 7 to about 20 psi per filter element. The feed juice and the recirculated retentate may be passed over the membrane at a cross flow velocity of from between 0.33 to about 0.8 meters/second.

According to a further aspect, a juice concentrate comprises substantially all of the flavor and fragrance components of a feed juice and from between 20° Brix to about 25° Brix.

Substantial advantage is achieved by this disclosed method of making a juice concentrate. In particular, it is advantageous to pass the juice tangentially over a reverse osmosis membrane at ambient temperatures. This is highly advantageous since the juice retains more of its freshly squeezed flavor and fragrance and the energy used to produce juice in this manner is lower than conventional methods. Substantial advantage is achieved by this disclosed juice concentrate. In particular, substantially all of the flavor and fragrance components are retained by the concentrate. This is highly advantageous because of consumer preference.

These and additional features and advantages of the invention disclosed here will be further understood from the following detailed disclosure of the various embodiments.

### BRIEF DESCRIPTION OF THE DRAWINGS

Various embodiments of the invention are described below with reference to the accompanying drawings in which:

FIG. 1 is a simplified drawing of the juice concentration apparatus;

FIG. 2 is a simplified process flow diagram of the juice concentration method;

FIG. 3 is a simplified process flow diagram of the juice concentration method using multiple membrane elements in series; and

FIG. 4 is a simplified process flow diagram of the juice concentration method using multiple membrane elements in parallel.

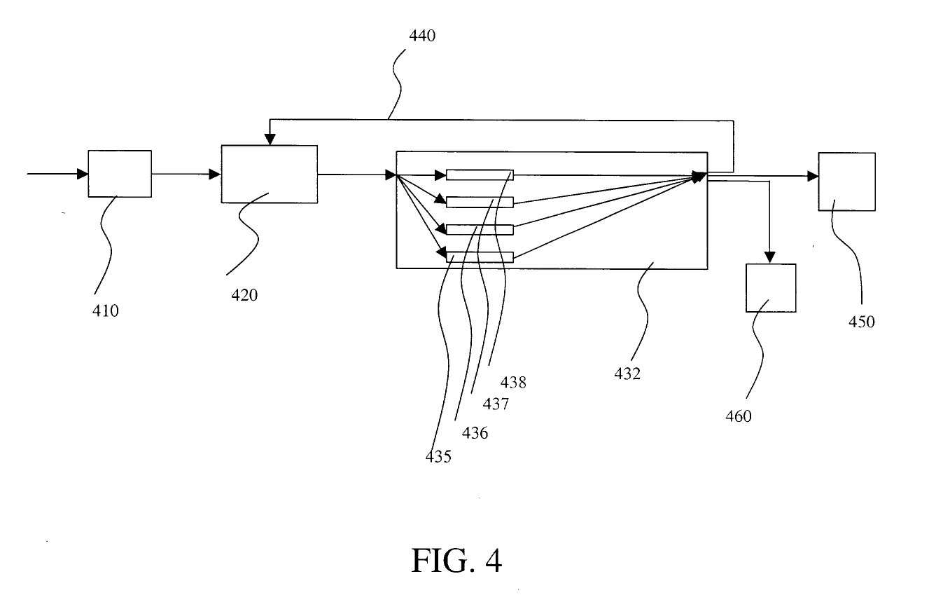

The figures referred to above are not drawn necessarily to scale and should be understood to present a representation of the invention, illustrative of the principles involved. Some features of the method of concentrating juice and the juice concentrate produced by practicing the method depicted in the drawings have been enlarged or distorted relative to others to facilitate explanation and understanding.

### DETAILED DESCRIPTION OF VARIOUS EMBODIMENTS

The examples given here are only illustrative, and it should be understood that these process are appropriate for any type of fruit juice. A person skilled in the art, having the benefit of this disclosure would know how to adapt the examples given for their particular purpose.

As disclosed here, a feed juice may comprise a juice extracted from any type of fruit. The juice may be freshly extracted, extracted then frozen and thawed, or otherwise treated by a method known in the art. In some aspects of the invention, the feed juice is an unprocessed juice, an unprocessed juice being a juice that has not been further processed after extraction, the unprocessed juice having substantially all of the suspended solids, pulp solids, flavor, and fragrance of the extracted juice. For example, the centrifuge step to remove oil from orange juice in the example below is not considered further processing. However, centrifuging orange juice to remove pulp or suspended solids would be considered further processing. The feed juice may have any level of Brix. In some aspects of the invention, the feed juice has Brix levels from approximately between 4° Brix to about 12° Brix. In some aspects of the invention, the juice contains from about 7% to about 18% pulp solids. It may be preferable, in some instances, for the pulp solids of the juice to be from between 9% and about 12% to ensure that the fruit is sufficiently ripe, but not overly so. Pulp solids, as used here, is meant to encompass the concepts to pulp, fruit solids, and suspended solids. The optimal levels will depend, in part, on the type of fruit from which the juice is extracted. One with skill in the art, having the benefit of this disclosure, would be able to determine the proper level of soluble solids and Brix to suit their particular purpose.

As used here, “passing a feed juice over a reverse osmosis membrane” should be understood to mean filtering a juice with a reverse osmosis membrane. For example, the juice may be passed over one surface and the molecules with a molecular weight below from about between 800 to about 50 pass through the membrane. In some aspects of the invention, the feed juice may be passed over the membrane at about between 250 to about 1000 psi. In other aspects of the invention, the pressure drop across the membrane may be from between 30 to about 150 psi.

Alternately, one may pass the feed juice through a filter apparatus comprising one or more reverse osmosis membranes, know as membrane elements. According to some aspects, multiple reverse osmosis membrane elements may be arranged in parallel and according to others the reverse osmosis membrane elements may be arranged in series. The pressure drop across the membranes may be from between 7 to about 20 psi per membrane element. The entire feed juice stream passes through each membrane element of the filter apparatus sequentially if the reverse osmosis membrane elements are arranged in series. The feed juice stream is divided into multiple paths and each volume may be fed into a different reverse osmosis membrane element of the filter apparatus if the membrane elements are arranged in parallel. In other embodiments, the reverse osmosis membrane elements may be both in series and in parallel within the same filter apparatus. One with skill in the art, having the benefit of this disclosure would be able to determine a membrane element configuration appropriate for their particular purpose.

A reverse osmosis membrane should be understood here to include semipermeable, porous membrane barrier. The membrane of this invention call be any type of membrane operative to concentrate juice without removing any of the flavor or fragrance components of the juice. The reverse osmosis membrane, or membrane element, in some aspects, has a molecular weight cutoff of from between 0.1 Å to about 10 Å. This range may be preferable because it allows the retentate to retain all of the flavor and aroma of freshly squeezed juice. In certain aspects, the membrane may be a spiral wound reverse osmosis membrane. In other aspects, the membrane may be spiral wound reverse osmosis membrane with spacers to create good flow through the membrane. The reverse osmosis membranes disclosed here, in some aspects, may have a surface that does not bind large organic molecules, such as proteins and polysaccharides. The reverse osmosis membrane, according to some aspects, may be made of polyimide, polyamide, thin-film composite, polymers, plastics, or any other material a person with skill in the art having the benefit of this disclosure would find appropriate for their particular purpose.

According to some aspects, the reverse osmosis membrane, or membrane element, includes spacers. The spacers may be made, for example, from between 25 to about 70 mm thick. The spacers, however, may be made to any thickness determined to improve flow through the membrane. The spacers may also be, for example, corrugated, ridged, ribbed, or grooved. Suitable materials for the spacers, may be, for example, polypropylene, nylon, or any polymer a person with skill in the art having the benefit of this disclosure would find appropriate for their particular purpose. The spacers may be beneficial because they decrease membrane clogging and allow for increased flow of fluid through the membrane.

As used here a retentate may be considered the material or fluid filtered by the reverse osmosis membrane, in other words, the material that does not pass through the reverse osmosis membrane. The material flowing through membrane is known as filtrate, or waste. In certain aspects, the filtrate is essentially water. This may be desirable because it is good to keep substantially all of the flavor and fragrance components in the retentate.

In some aspects, substantially all of the flavor and fragrance molecules and components of the feed juice are retained in the retentate. This is beneficial because it give the juice concentrate the flavor and fragrance of freshly squeezed juice, which is desired by consumers. Substantially all of the flavor and fragrance molecules should be understood to mean that from between 90% to about 100% of the flavor and fragrance molecules and components of the feed juice are retained by the juice concentrate. In other words, only from between 0% to 10% of the flavor and fragrance molecules pass through the reverse osmosis membrane.

As used here, “recirculating the retentate over the membrane” should be understood to mean that once passed over the membrane, the feed juice passes over the membrane again. According to some aspects, the feed juice passes continuously over the membrane until the feed juice and the retentate reach from between 20° Brix to about 25° Brix to form a juice concentrate. Alternatively, one might pass the retentate only one more time over the membrane. A sensor may be used to detect the Brix level of the juice to determine whether the feed juice and/or the retentate may need to be passed over the membrane again. There may also be, for example, other additional components, such as valves, sensor, and/or processors used to assess properties of the feed juice stream and/or the retentate during the juice concentrating process.

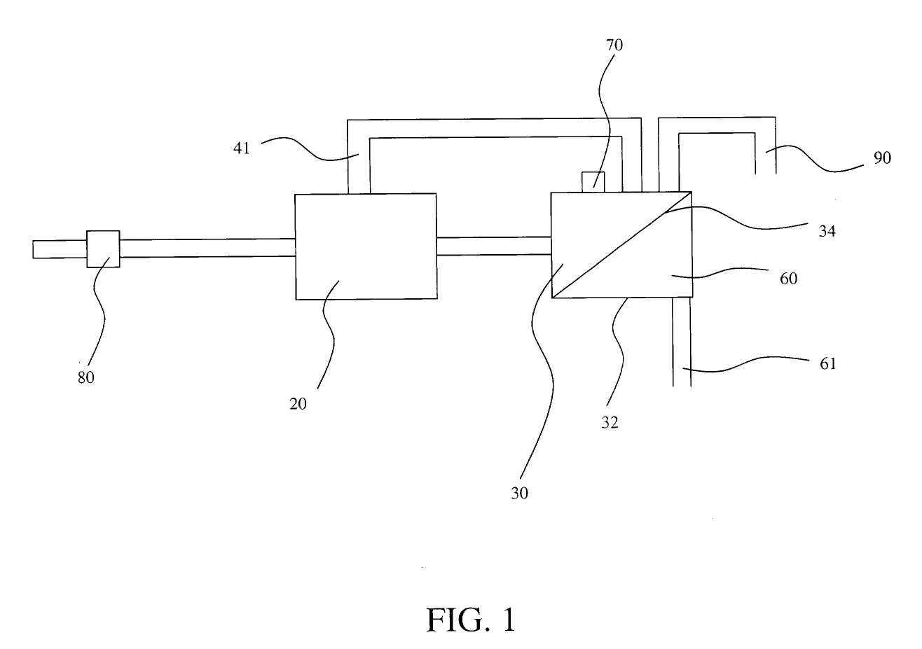

With reference to FIG. 1, in various aspects the feed juice is pumped using pump 80 through heat exchanger 20 into first reservoir 30 where it passes over membrane 34. The retentate is then pumped from first reservoir 30 into recirculating conduit 41 and back through heat exchanger 20. The retentate is then pumped back into first reservoir 30 where it passes over membrane 34 for a second time. This process is repeated until sensor 70 detects a Brix level of from between 18° Brix to about 24° Brix. The filtrate, the material that is filtered out of the juice. travels through membrane 34 into second reservoir 60 and into first output conduit 61. The concentrated juice product exits first reservoir 30 by way of second output conduit 90.

The feed juice, according to various aspects may be provided in a continuous flow stream. As used here, a continuous flow stream means that, whether feed juice or retentate, the juice flows to the first reservoir in a continuous fashion without a break in the stream of juice flow. In other words, according to some aspects of the invention, the juice flows unceasingly over the membrane during the concentration process. In various aspects, the retentate may be recirculated into the feed juice before the feed juice passes through the heat exchanger such that the feed juice and the recirculated retentate mix together and pass through the heat exchanger together before passing into the first reservoir. In other aspects, the retentate and the feed juice do not mix. The flow of recirculated juice may be done in any fashion that would he evident to one with skill in the art having the benefit of this disclosure.

Previously it was thought that reverse osmosis membranes were not useful for methods such as this because of membrane fouling problems. Reverse osmosis membranes were also thought not to be useful because of the extremely high pressures necessary to concentrate juice through a reverse osmosis membrane. The process disclosed here overcomes these difficulties in part because in some aspects of the invention, the feed juice, the feed juice and the retentate, and/or the retentate may be passed over the membrane at a velocity of from between 0.33 to about 0.8 meters/second. The process disclosed here also overcomes these difficulties, in part because the feed juice, the feed juice and retentate, and/or the retentate flows over the membrane tangentially. Tangential flow, as understood here, means that the fluid flows toward the membrane tangential to the surface of the membrane. Tangential flow prevents clogging and fouling of the membrane by creating turbulence over the surface of the membrane. The tangential flow produces a desirable degree of turbulence at the membrane surface to sweep the fouling molecules away from the membrane surface before they adhere. According to some aspects, tangential flow may be at a velocity of from between 0.33 to about 0.8 meters/second.

In some aspects of the invention, the feed juice, the feed juice and the retentate, and the retentate may be maintained at a temperature of from between 20° C. to about 25° during the concentration process. This may be done by initially passing the feed juice through a heat exchanger and then by passing the retentate though the heat exchanger before it is circulated over the membrane. In some aspects, the feed juice and retentate may alternatively be cooled while in the first reservoir, or cooled in the first reservoir and by a heat exchanger in line with the filter apparatus.

The feed juice may be extracted from fruits such as, apricot, cranberry, blueberry, grape, peach, grapefruit, pear, papaya, banana, pineapple, apple, kiwi, raspberry, strawberry, aloe, guava, mango, and citrus fruits, including, orange, lemon, lime, tangerine. Feed juice may also be made from a mixture of these fruits. One with skill in the art, having the benefit of this disclosure would be able to adapt the disclosed process to suit their particular purpose.

Juice concentrate made from citrus fruit can be made, for example from four varieties of oranges, Pineapple, Hamlin, Parson Brown, and principally, Valencia oranges. Tangerines, mandarin oranges, blood oranges, and naval oranges can also be used. The juices from these oranges can be used alone or blended to produce optimum flavor characteristics.

In some aspects of this invention, to produce the superior juice concentrate of this invention, using as an example orange juice, the orange juice may be processed with a minimum of exposure to oxygen and a minimum exposure to temperatures above 40° C. The oranges may be first washed with a disinfecting solution. For example, a hypochlorite solution or other solutions may be used as is known in the art. The oranges are then thoroughly rinsed with water before subjecting them to juice extraction. Juice extraction can be carried out by any other method known of obtaining juice from fruits, such as by automatic juicing machines. In some aspects, such as when using a citrus fruit, a method that minimizes extraction of peel oil is preferred. The peel oil content of the juice may be between 0.01% to 0.03%. An optional step is to centrifuge the juice once separated from the rag and seeds to remove the oil from the juice because peel oil contributes a bitter note to orange juice.

According the various aspects, the oil from citrus fruits can be removed from the juice after extraction. This can be done by centrifuging the juice just enough so that the oil rises to the top and is easily removed. The oil may also be removed by any method known to those skilled in the art having the benefit of this disclosure. The oil, also known as limonene, can be further processed.

The raw juice exiting from the extractor or squeezing device contains pulp, rag and seeds. The rag and seed may optionally be separated from the juice in a finisher, by hand, or by any method know to one having skill in the art. The size of the screen in the finisher controls both the quantity and the size of the pulp desired in the juice. According to some aspects of this invention, the screen size may vary from about 0.5 mm to about 2.5 mm. This step is also not considered to be further processing of the juice.

In one aspect, to maintain the quality, freshness, aroma, and flavor; the concentrated juice should be chilled to a temperature below about 30° C., and preferably below 5° C. after the juice is extracted. This may be done by rapid chilling techniques, or by any other technique know to those with skill in the art.

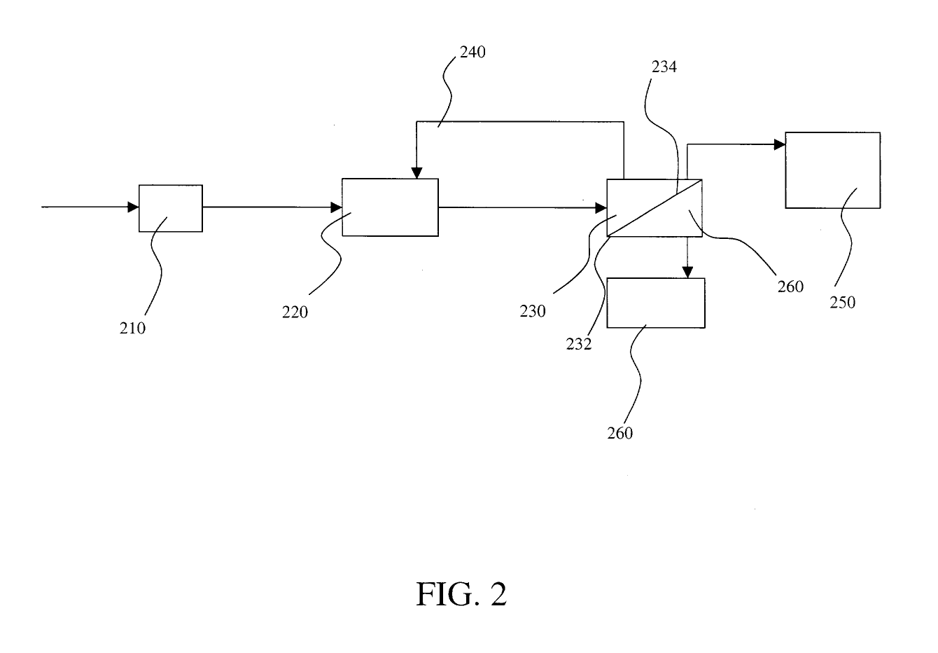

With reference to FIG. 2, an example of the juice concentration method disclosed is given, using as the example a juice concentrate made from oranges. Valencia oranges are washed in a solution containing hypochlorite. The oranges are rinsed with fresh tap water and passed into juice extractor 210, or example an FMC extractor. A finisher using a 0.238 cm screen is used to separate the rag and seed from the juice. The oil is then separated from the juice by a centrifugation step. The juice from the finisher is now considered a feed juice. The juice fraction, without the oil contains approximately 10% pulp solids and is approximately 10° Brix. The feed juice is pumped through a heat exchanger 220. The heat exchanger 220 maintains the temperature of the juice at approximately 25° C. The feed juice is then pumped into the first reservoir 230 of the filtering apparatus 232 containing the reverse osmosis membrane 234. In this example, the juice is pumped over the reverse osmosis membrane in a tangential flow to create turbulence at the membrane surface. The juice feed is fed into the first reservoir 230 of the filter apparatus 232 at approximately 250 to about 1000 psi. There is a pressure drop across the membrane of between about 30 to about 150 psi. The feed juice may be passed over the reverse osmosis membrane at a velocity of from between 0.33 to about 0.8 meters/second. The reverse osmosis membrane 234 may be a spiral wound, tubular reverse osmosis membrane configuration. The filtrate passing through the membrane 234 passes into second reservoir 260. Typical membranes may be found commercially from, for example, Osmonics, Inc., Koch, Inc., and from Dow Film Tech, Inc. The juice, now a retentate, is recirculated 240 over the membrane until enough water is removed to make a product between about 20° to about 25° Brix. The juice concentrate is then pumped into a pasteurization unit 250 where it is pasteurized. The juice concentrate product is stored at from between 5° C. or below.

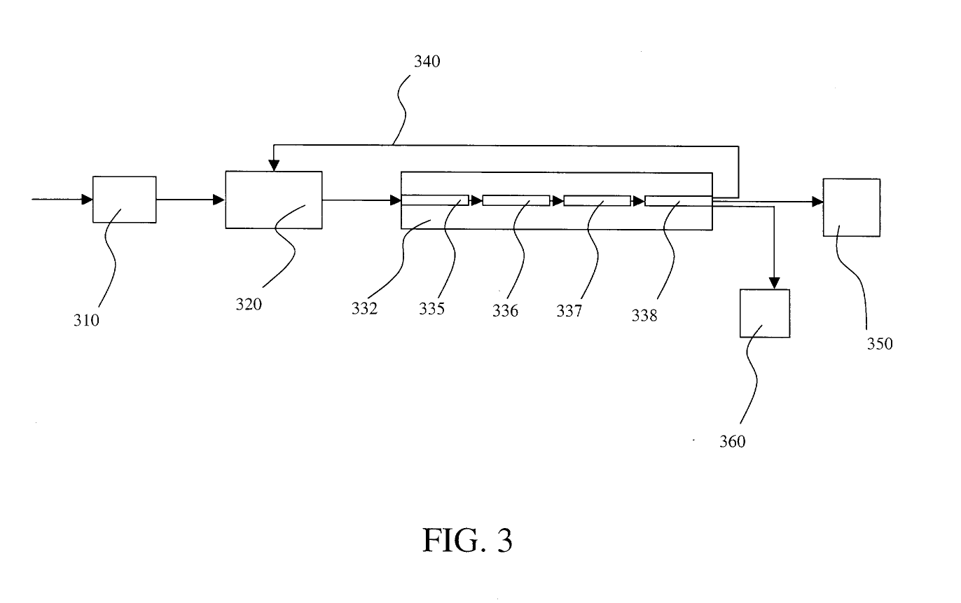

With reference to FIG. 3, this is one example of a filter apparatus with multiple filter elements arranged in series. The feed juice is pumped with pump 310 through a heat exchanger 320. The heat exchanger 320 maintains the temperature of the juice at approximately 25° C. The feed juice is then pumped into the first membrane element 335 of the filtering apparatus 332. The feed juice is then pumped into the second membrane element 336, into the third membrane element 337, and finally into the fourth membrane element 338. The feed juice is fed into each filter element of the filtering apparatus 232 at approximately 250 to about 1000 psi. There is a pressure drop across each membrane element of between about 7 to about 20 psi. The feed juice may be passed over each membrane element at a velocity of from between 0.33 to about 0.8 meters/second. The juice, now a retentate, is recirculated 340 over each membrane element until enough water is removed to make a product between about 20° to about 25° Brix. The juice concentrate is then pumped into a pasteurization unit 350 where it is pasteurized. The filtrate is pumped into a first waste container 360. The juice concentrate product is stored at from between 5° C. or below.

With reference to FIG. 3, this is one example of a filter apparatus with multiple filter elements arranged in parallel. The feed juice is pumped with pump 410 through a heat exchanger 420. The heat exchanger 420 maintains the temperature of the juice at approximately 25° C. The feed juice stream is then divided and pumped into first membrane element 435, second membrane element 436, third membrane element 437, and fourth membrane element 438 of the filtering apparatus 432. The feed juice is fed into each filter element of the filtering apparatus 232 at approximately 250 to about 1000 psi. There is a pressure drop across each membrane element of between about 7 to about 20 psi. The feed juice may be passed over each membrane element at a velocity of from between 0.33 to about 0.8 meters/second. The juice, now a retentate, is recirculated 440 over each of the multiple membrane elements until enough water is removed to make a product between about 20° to about 25° Brix. The juice concentrate is then pumped into a pasteurization unit 450 where it is pasteurized. The filtrate is pumped into a first waste container 460. The juice concentrate product is stored at from between 5° C. or below.

The juice concentrate may then optionally be packed into cans, foil containers, bottles, drums, etc. To insure long-term oxidative stability, the packaging compounds will be impermeable to oxygen. Optionally, the concentrate can be packed under nitrogen. Other methods of packaging and storing the juice will be evident to those with skill in the art having the benefit of this disclosure

The juice concentrate disclosed here may be optionally pasteurized. The pasteurization step helps maintain the storage stability of the juice concentrate. Pasteurization controls the concentration of the bacteria and other microbes so that the product does not deteriorate during storage, or does not deteriorate when reconstituted after a reasonable period. Moreover, pasteurization reduces the activity of the pectin esterase enzyme. Pectin esterase is believed to be responsible for demethylating the pectin and thus destroying the cloud of the orange juice. Pectin esterase is somewhat active even at 0° C. Thus, the highly preferred compositions herein will contain a minimal level of pectin esterase enzyme.

The juice concentrate product may be pasteurized, for example, by using a high temperature, short residence pasteurization technique. The juice concentrate is heated to a temperature of from about 80° C. to about 95° C. for from about 3 to about 12 seconds. The juice concentrate is then rapidly cooled to a temperature of about −10° C. to about 5° C. The system used to pasteurize the juice must be closed and be conducted in a manner such that the juice is not exposed to an oxidative atmosphere. It should be understood that the pasteurization step can be performed at any stage in the processing. Other methods of pasteurization may be used and the methods will be apparent to those with skill in the art having the benefit of this disclosure.

The juice concentrate may be optionally further concentrated to between about 60° Brix to about 65° Brix. The further concentration may be by evaporative concentration, freeze concentration, TASTE concentration methods, or the like. Other methods of further concentration may be used and the other methods will be apparent to those with skill in the art having the benefit of this disclosure. It may be beneficial to further concentrate the juice concentrate to further reduce shipping and storage costs. In addition to further concentration, the juice concentrate may be further processed by other methods. For example, the juice concentrate may be mixed with other liquids, reconstituted, cooked, clarified, or condensed. Other methods of further processing the juice concentrate will be apparent to those with skill in the art having the benefit of this disclosure.

Although the invention has been defined using the appended claims, these claims are illustrative in that aspects of the invention are intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

What is claimed is:

1. A method of concentrating juice comprising:
passing a feed juice over a reverse osmosis membrane to form a retentate; and
recirculating the retentate over the membrane until the feed juice and the retentate reach from between 20° Brix to about 25° Brix to form a juice concentrate.

2. The method of claim 1, wherein the reverse osmosis membrane is a spiral wound membrane.

3. The method of claim 1, wherein the feed juice comprises from between 7% to about 18% pulp solids by volume.

4. The method of claim 1, wherein the feed juice comprises from approximately between 4° Brix to about 12° Brix.

5. The method of claim 1, wherein the reverse osmosis membrane has pores sized from between about 0.1 Å to about 10 Å.

6. The method of claim 1, further comprising providing the feed juice in a continuous flow stream.

7. The method of claim 1, further comprising providing the feed juice and the recirculated retentate in a continuous flow stream.

8. The method of claim 1, wherein the feed juice is passed over the membrane at about between 250 to about 1000 psi.

9. The method of claim 1, wherein the membrane comprises a pressure drop across the membrane of from between 30 to about 150 psi.

10. The method of claim 1, wherein the reverse osmosis membrane comprises two or more membrane elements.

11. The method of claim 10, pressure drop across each membrane element is from between 7 to about 20 psi.

12. The method of claim 10, wherein the membrane elements are arranged in series.

13. The method of claim 10, wherein the membrane elements are arranged in parallel.

14. The method of claim 1, wherein the feed juice and the recirculated retentate are passed over the membrane at a cross flow velocity of from between 0.33 to about 0.8 meters/second.

15. The method of claim 1, wherein the feed juice flows over a surface of the membrane tangentially.

16. The method of claim 1, further comprising passing the feed juice through a heat exchanger before passing the feed juice over the reverse osmosis membrane.

17. The method of claim 1, further comprising passing the retentate through a heat exchanger before recirculating the retentate.

18. The method of claim 1, wherein the feed juice and the retentate are maintained at temperature of about between 20° C. to about 25° C.

19. The method of claim 1, further comprising extracting the feed juice from citrus fruit.

20. The method of claim 1, further comprising extracting the feed juice from oranges.

21. The method of claim 1, further comprising extracting the feed juice from oranges of the Valencia variety.

22. The method of claim 1, further comprising extracting the feed juice from the fruits of the group consisting of: apricot, cranberry, blueberry, grape, orange, lemon, lime, peach, grapefruit, tangerine, pear, papaya, banana, pineapple, apple, kiwi, raspberry, strawberry, aloe, guava, mango, or a mixture.

23. The method of claim 1, further comprising extracting juice from fruit to form the feed juice.

24. The method of claim 1, further comprising pasteurizing the juice concentrate.

25. The method of claim 1, further comprising further concentrating the juice concentrate.

26. A juice concentrate produced by a process comprising:
extracting juice from fruit to form a feed juice;
passing the feed juice over a reverse osmosis membrane to form a retentate; and
recirculating the retentate over the membrane until the feed juice and the retentate reach from between 20° Brix to about 25° Brix to form a juice concentrate.

27. The juice concentrate produced by a process according to claim 26, further comprising passing the feed juice through a heat exchanger before passing the feed juice over the reverse osmosis membrane.

27. The juice concentrate produced by a process according to claim 26, wherein the reverse osmosis membrane comprises two or more membrane elements.

28. A juice concentrate comprising substantially all of the flavor and fragrance components of a feed juice and from between 20° Brix to about 25° Brix.
